(19) United States
(12) Patent Application Publication
(10) Pub. No.: US 2008/0258886 A1
(43) Pub. Date: Oct. 23, 2008

(54) Key locator and method of use thereof

(76) Inventor: Pamela L. Summerlin, Rockmart, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 11/787,459

(22) Filed: Apr. 17, 2007

(51) Int. Cl. B60R 25/10

(52) U.S. Cl. 340/426.35

(57) ABSTRACT

A key locator apparatus is provided comprising at least one key having at least one key code, and a locator, programmed with at least one key code to be transmitted, wherein the locator sends an activation signal to the key to activate an alarm secured about the key that is activated if the transmitted key code authenticity is confirmed, thus allowing a user to find the key.

### FIELD OF INVENTION

The present invention relates to object locating apparatuses and in particular to a key locator and method of use thereof, the key locator being utilized to signal a key, wherein validation of the communications from the key locator to the key is based on a manufacturer's code within the key.

### BACKGROUND ART

Multiple devices involve electronic keys, wherein the keys typically have inserted therein a transmitter, receiver, and/or a computer chip. These electronic keys provide an extra layer of security and serve as a deterrent to thieves by requiring the device to be unlocked, such as an automobile, to recognize the key. This is typically done in a wireless fashion. Electronic vehicle keys accomplish this through a code within the key which must be recognized by the device being started. While electronic keys do add security, the added features within the key also make them very expensive to replace. Because the key is digitally encoded, a driver who loses his keys must typically go back to the dealership where the car was purchased and pay an excessively high amount of money for a replacement key to obtain all of the same security features and amenities. However, the key may merely be lost in the vicinity of the vehicle or actually within the vehicle and readily locatable. Unfortunately, there currently exists no inexpensive way to locate such a lost electronic key.

There are multiple products available on the market which may be utilized to help locate or find a person's keys. Some of these products require the user whistle or clap before an alarm, typically located on the key ring goes off. Others may utilize radio frequency transmission. This can result in false alarms reacting to any source of noise and can also become damaged without any damage to the key, thus nullifying their purpose. These products are also susceptible to false positives as multiple devices around the user may emit radio waves on the same frequency. As a further problem, when multiple receivers are utilized it is difficult to find a single lost key without initiating a false alarm from any other receivers in the vicinity.

Therefore, it is readily apparent that there is a need for a key locator and method of use thereof, wherein these deficiencies are minimized or overcome, thereby enabling a user to find lost or misplaced keys while preventing false alarms.

### SUMMARY OF THE INVENTION

Briefly described, in a preferred embodiment, the present invention overcomes the above-mentioned disadvantages and meets the recognized need for such a device by providing a key locator which uses a key code to activate an alarm contained within or in close proximity the key, thus allowing a user to find the misplaced key while preventing false positives.

According to its major aspects and broadly stated, the present invention in a preferred form is a key locating system comprising at least one key and a locator, with at least one of the keys further comprising a receiving mechanism, a power source, and an alarm. The locator further comprises a power source, a transmitting mechanism and a database of key codes, wherein the database of key codes is comprised of at least one key code, wherein upon selection, the key code is sent from the locator through the transmitting mechanism via an activation signal, and wherein the activation signal is received by the receiving mechanism of at least one of the keys, thereby activating the alarm if the transmitted key code authenticates the activation signal through comparison of the key code located within the key. A deactivation signal is also provided for, wherein the deactivation signal is sent from the locator via the transmitting mechanism, and wherein the deactivation signal is received by the receiving mechanism of at least one of the keys, thereby deactivating the alarm if the transmitted key code authenticates the deactivation signal through comparison of the key code located within the key. Further, the activation signal and deactivation signal are preferably based on a manufacturer code, wherein the manufacturer code is preprogrammed into the key. The preprogrammed code can be obtained securely from the key supplier and input into a locating device, wherein activation of the locating device sends the key code to the receiving key, activating an alarm therein. In such fashion, lost keys are readily located, obviating the cost to replace expensive keys.

More specifically, the present invention is a key locating apparatus comprising at least one key, wherein at least one of the keys has at least one internal key code intended to be unique and a locator, wherein the locator is programmed with at least the same code intended to be unique or a derivative thereof, and wherein when the locator is activated, an activation signal is sent to the key, coded with the code intended to be unique or derivative thereof, which corresponds to the key. An alarm is also provided for within the key, wherein the alarm is activated by the activation signal sent from the locator, thus allowing the key emit a sound thereby permitting the key to be found upon activation of the locator. Further, because a code intended to be unique is used, the chances of a false alarm are highly reduced.

In another preferred embodiment, the key locating apparatus comprises a memory mechanism, a comparator and a power supply, wherein the memory mechanism contains the internal key code and a receiving mechanism. The receiving mechanism receives the activation signal containing the transmitted key code and the comparator compares the internal key code to the transmitted key code. Once activated, the power source powers an alarm, wherein activation takes place if the transmitted key code is authorized by said comparator based on a relationship to the internal key code. Thus a key comprises the key locating system within the key (other than the transmitter) and additional hardware, other than the locator/transmitter, is not needed to locate the key.

In a further preferred embodiment a key locating system comprises a memory mechanism having a transmitted key code, a transmitting mechanism adapted to transmit the transmitted key code, a receiving power source and a key fob comprising a power source, a receiving mechanism adapted to receive said activation signal containing the transmitted key code from the locator, wherein the receiving mechanism receives the internal key code from the key, a memory mechanism, wherein the memory mechanism stores the transmitted key code, and a comparator adapted to compare the internal key code to the transmitted key code, a power field generated by the power source and received by the receiving power source thus powering the key, wherein the alarm is activated if the transmitted key code is authorized by said comparator in relation to the internal key code. Thus a key fob is provided and the manufacture of keys does not have to be changed. Thus, an off the shelf key locator can be provided and programmed with the key code without changing existing manufacturing techniques.

In a further embodiment, a specific key code may be selected by a user out of a plurality of key codes stored on a database within the locator, wherein the specific key code is specifically coded to a single key. Thus the same locator can be used for multiple keys, thereby reducing the number of key locators one would need to buy and maintain in one's possession. Further, by selecting a specific key code, only the alarm on the desired key will respond, thereby easing use and reducing false responses by unselected keys or other units.

In a still further embodiment, the key code is based on a manufacturer code, wherein the manufacturer code is preprogrammed into a computer chip located within the key. In one preferred embodiment, the code intended to be unique can also be the manufacturer code which comes with the key. As most electronic keys already have a code intended to be unique, the key is provided without further or additional programming. This does not increase the manufacturing cost, while increasing the functionality of the key. Further, having the code intended to be unique within the key reduces the likelihood of a false alarm.

In a preferred embodiment the alarm on the key may be an audible signal so that the user can hear the alarm when the locator is activated, a visual signal such as a light to allow the user to see the key alarm when the locator is activated, or any combination of audio, visual, physical, or other forms of alarms. Other forms of alarms and notifications as understood in the art may also be used, such as for exemplary purposes only and not meant to be limiting, vibrations, movement, bells, specific ring tones, or any combination thereof.

In another preferred embodiment, the key may further comprise a power source. The power source would be used to power the alarm within the key. The locator also contains a power source. A power source is meant to be understood as it would by one skilled in the art, thus for exemplary purposes only, and not meant to be limiting could include a battery, a capacitor, electromagnetic field, or any combination thereof. The batteries or capacitors may also preferably recharged via connections or wirelessly. This allows the alarm to receive a sufficient level of power to notify the user where the key is located.

In a further embodiment, the activation signal emitting from the locator may be terminated by a deactivation mechanism on the locator. The deactivation can occur after a designated period of time or may occur at the request of the user, by pressing a second button or releasing the activation button, thereby causing the activation signal to terminate. In an alternate embodiment, the locator preferably sends out an affirmative deactivation signal causing the alarm to cease. Thus once the key is located, the alarm can be turned off, conserving power and preventing any annoyance caused by the alarm. Further, if an affirmative deactivation signal is sent, the locator need not continue to transmit the activation signal once the alarm has begun responding. This saves battery power within the locator.

In an alternate embodiment, the key comprises a transmitting mechanism which sends a found signal to the locator when the key receives the activation signal. If the locator has not received the found signal from the key, then the locator would continue to transmit the activation signal. In another embodiment, if the activation signal is terminated prior to finding the key, a notification could be provided to the user. Thus the locator could continue sending an activation signal until the key was located to prevent the user from repeatedly pressing the activation button. Further, if the user was notified when the activation signal terminated the user would know when to press the activation button again, thus easing the use of the locator while preventing unnecessary pressing of the activation button.

In still another preferred embodiment, the locator may comprise an attachment clip, thereby allowing the locator to be clipped in a convenient location such as a purse, belt, pocket, or other similarly convenient spot.

In yet a further embodiment, a key code is stored in a database within the locator designed to contain multiple key codes. Thus multiple key codes can be stored in one locator and any one of a plurality of keys can be located by selecting the correct key code on the locator. Thus, when an activation signal is sent out, only the key desired by a user responds. A user may select the key by any means known in the art, but for exemplary purposes only, and not meant to be limiting, a user could select the desired key via a button or through a display which allows the user to scroll through available keys.

In yet another preferred embodiment, the locator comprises a notification to alert a user that the locator is active. This can be accomplished in numerous ways, but for exemplary purposes only and not meant to be limiting, LED lights next to a nickname of a specific key could be used or a display could be used. One skilled in the art would realize there are multiple ways to accomplish the notification and accordingly not limit the notification to the examples given. When the activation signal is no longer transmitted from the locator either after a designated period of time or at the request of the user, the notification would cease. This type of a notification would allow a user to know if an activation signal was being sent out and to which key the signal was being sent. This would allow the user to confirm the locator has power, is still transmitting the activation signal, and that the correct key and corresponding key code were selected.

In still a further embodiment, the key comprises a receiving mechanism for receiving either the activation signal, deactivation signal, or both. By having a receiving mechanism located within one of the keys, the key can receive signals from the locator, thus activating the alarm to enable a user to find the key.

In use, a method of locating a key is provided by activating a locator, wherein the activating step transmits a signal from the locator, the signal is received at a key, wherein the signal is coded for the key, and the user is notified of the location of the key via an alarm. Thus a use for the key locator is provided, allowing a user to locate a key.

The use may preferably further include the step of deactivating the alarm via an overt deactivation signal sent from the locator, wherein the deactivation signal would terminate the alarm. As an alternative, the activation signal would cease after a desired amount of time or after the user requests the locator to stop sending the activation signal. Thus power is saved and any annoyance created by the alarm is minimized after the key is found.

In a further preferred use, the signals which are sent between the locator and the key are derived from a chip on the key which contains a code inserted by the manufacturer. Thus, an existing code can be used, reducing manufacturing costs and steps, thereby increasing efficiency. Further, having a code intended to be unique helps prevent false alarms. Although a key is used in the following examples, it should be understood by one skilled in the art that the same type apparatus could be applied to items other than keys via an attachment piece, including for exemplary purposes, and not meant to be limiting, purses, remote controls, wallets, valuables, glasses cases, or other things often misplaced.

In still another preferred embodiment, a use is provided comprising the steps of obtaining a mechanism made by a manufacturer, wherein the mechanism has a coded key, and wherein the coded key comprises a manufacturer key code; obtaining a transmitted key code from an originator, wherein the transmitted key code is selected to be authenticated by the manufacturer key code, and wherein the transmitted key code is provided via a secure method; obtaining a programmable transmitting mechanism; programming the transmitted key code into the programmable transmitting mechanism; transmitting the transmitted key code via the programmable transmitting mechanism; receiving the transmitted key code at the coded key; comparing the transmitted key code with the manufacturer key code; and activating an alarm when the transmitted key code resembles the manufacturer key code in a way to confirm authenticity. Thus the manufacturer key code can be provided to the purchaser of a device, for exemplary purposes only and not meant to be limiting, a car, and the purchaser of the device can request a key code which is delivered securely to the purchaser. With only the manufacturer, purchaser, and possibly a dealer knowing the manufacturer key code, absolutely security is therefore provided. The purchaser in one embodiment may obtain the manufacturer code directly from the manufacturer, or in alternate embodiments, it may be provided during the purchase of the device or may be requested from the dealer at a later time.

Accordingly, a feature and advantage of the present invention is its ability to provide a key locator with a code intended to be unique thereby reducing the number of false positive signals.

Another feature and advantage of the present invention is its ability to locate a key via a wireless transmission from the locator to the key.

Still another feature and advantage of the present invention is its ability to provide a key locator with a deactivation mechanism, thereby conserving power and minimizing any annoyance caused by the alarm on the key.

Yet another feature and advantage of the present invention is its ability to notify a user that the locator is working, thereby eliminating any frustration caused by products currently in the market which do not notify a user whether the locator is emitting a signal.

Yet still another feature and advantage of the present invention is transmitting only the desired transmitted key code selected from codes within a database within the locator so that only the alarm on the key which is sought is activated.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to the elements throughout, and in which:

FIG. 1 shows a front elevation view in partial cutaway, thus showing the internal components of a preferred embodiment of a key;

FIG. 2A shows a perspective back view of a preferred embodiment of a locator;

FIG. 2B shows a perspective front view of a preferred embodiment of a locator;

FIG. 2C shows a front perspective view in partial cutaway, thus showing the internal components of a preferred embodiment of a locator; and

FIG. 3 shows a perspective view in partial cutaway of a preferred embodiment of the apparatus, showing the device in operation.

### DETAILED DESCRIPTION OF THE PREFERRED AND SELECTED ALTERNATE EMBODIMENTS

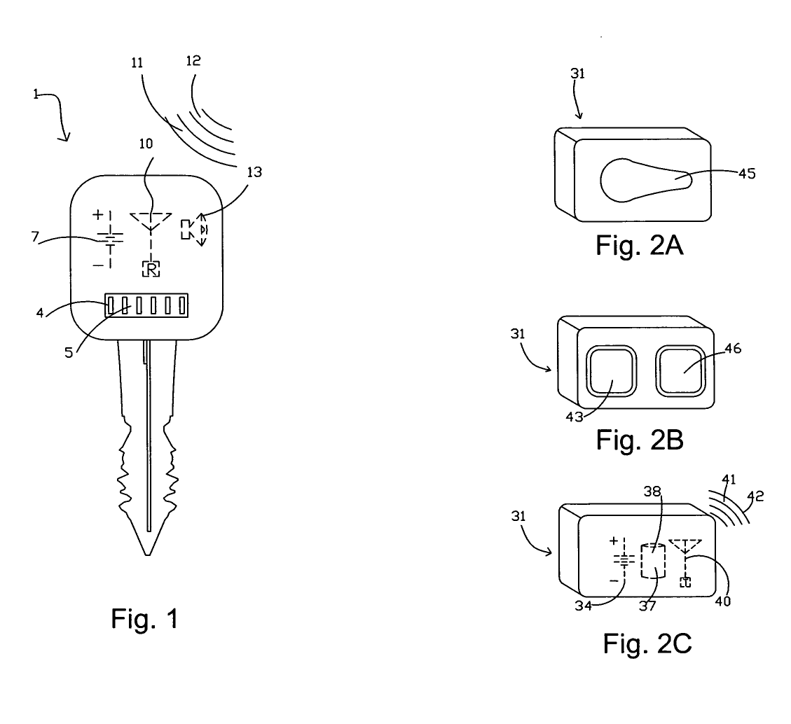

In describing the preferred and selected alternate embodiments of the present invention, as illustrated in FIGS. 1-3, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1, the present invention in a preferred embodiment comprises key 1, wherein key 1 preferably comprises memory mechanism 4, power source 7, receiving mechanism 10, and alarm 13. Memory mechanism 4, power source 7, receiving mechanism 10, and alarm 13 are preferably in electrical communication with each other. Memory mechanism comprise, for exemplary purposes only, and not meant to be limiting, ROM such as masked, PROM, EPROM, hybrid memory, such as NVRAM, EEPROM, flash, or other types of memory known in the arts.

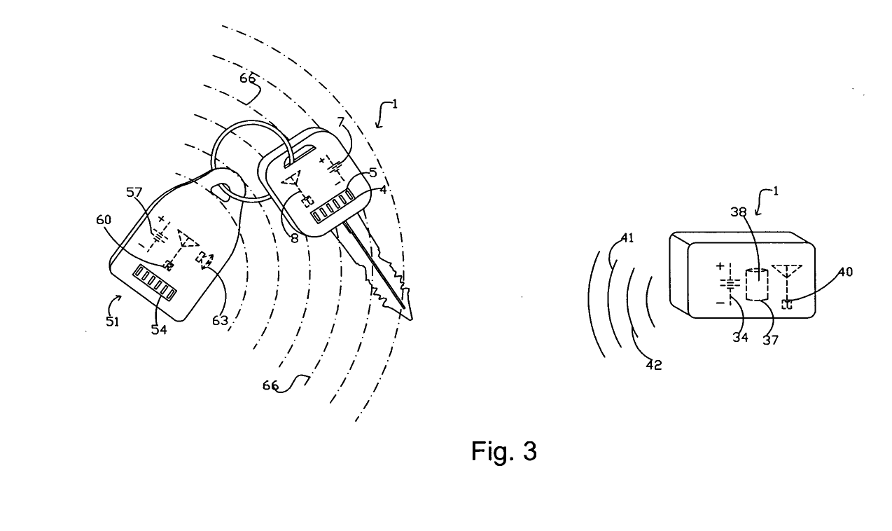

Referring now to FIGS. 1-3, transmitted activation signal 41 is sent from locator 31 (best shown in FIGS. 2A-3) and received activation signal 11 is received by receiving mechanism 10, wherein activation signals 11, 41 comprise the same signal but are referred to herein as transmitted or received depending on whether they are arriving at receiving mechanism 10 or emanating from locator 31, respectively. Receiving mechanism 10 may include any type of communicable reception mechanism known, but preferably may comprise a radio receiver, infrared receiver, or microphone. In an embodiment where activation signal 11, 41 is received by microphone 10, activation signal, 11, 41, is preferably of a frequency that can be heard or seen by neither humans nor animals. Receiving mechanism 10 is preferably in electrical communication with memory mechanism 4, wherein key code 5 is stored. Transmitted key code 38 (best shown in FIGS. 2C and 3), or a derivative thereof, is transmitted via activation signal 41 from locator 31, and compared with key code 5 stored in memory mechanism 4 within key 1. Key 1 preferably comprises necessary logic gates or controllers (not shown) to compare transmitted key code 38 with key code 5. If transmitted key code 38, or derivation thereof, matches or resembles in a way to confirm authenticity with key code 5 stored in memory mechanism 4, then alarm 13 is activated.

Referring more particularly to FIG. 1, alarm 13 within key 1 may be an audible signal or visual signal. Other forms of alarms and notifications as understood by those in the art may also be utilized, such as, for exemplary purposes only and not meant to be limiting, vibrations, movement, bells, specific ring tones or a combination of any of the above. Alarm 13 may be activated for a determinate period of time or may be deactivated through overt steps. Alarm 13 may also get louder, more quiet, brighter, dimmer, or display another characteristic, such as changing tones or colors, as locator 31 (best shown in FIGS. 2A-3) becomes closer in proximity to key 1.

In a preferred embodiment as shown in FIG. 1, receiving mechanism 10 may continue to receive activation signal 11, 41 from locator 31 (shown in FIGS. 2A-3) for a determinate amount of time. If transmitted code 38 contained within activation signal 11, 41 matches or resembles in a way to confirm authenticity, key code 5 stored in memory mechanism 4, then alarm 13 is activated. Once activation signal 11, 41 ceases, or transmitted key code 38 ceases to match key code 5 stored in memory mechanism 4 within key 1, alarm 13 is deactivated. In a preferred embodiment key code 5 is preset into memory mechanism 4 during manufacture of key 1.

In another preferred embodiment as shown in FIGS. 1-3, receiving mechanism 10 may receive deactivation signal 12, 42 from locator 31. Similarly to activation signals 11, 41, deactivation signals 12, 42 are one and the same, but respectively correspond to received deactivation signal 12 and transmitted deactivation signal 42. If transmitted key code 38 contained within deactivation signal 12, 42 matches or resembles in a way to confirm authenticity with key code 5 stored in memory mechanism 4, then alarm 13 is deactivated.

Referring now more particularly to FIG. 2A, the present invention in a preferred embodiment comprises locator 31 with attachment clip 45 disposed thereon. Attachment clip 45 allows user to conveniently secure locator 31 to belts, shirts, pants, shorts, purses, or similarly securable articles.

Referring now specifically to FIG. 1-2C, the present invention in a preferred embodiment comprises locator 31, activation button 43 and deactivation button 46. Upon pressing activation button 43, transmitting mechanism 40 within locator 31 preferably generates activation signal 11, 41, which is received by receiving mechanism 10 of key 1. Upon pressing deactivation button 43 transmitting mechanism 40 preferably ceases transmitting activation signal 11, 41 or selectively affirmatively sends deactivation signal 12, 42, thus resulting in cessation of alarm 13 of key 1.

In another preferred embodiment as shown in FIG. 2C, locator 31 comprises power source 34, key code database 37, and transmitting mechanism 40 all in electrical communication with each other. Transmitting mechanism 40 may selectively include any type of communicable transmitting mechanism know, but preferably comprises a radio transmitter, an infrared transmitter, or a speaker. Key code database 37 preferably comprises at least one transmitted key code 38 or a derivative thereof.

In yet another preferred embodiment as shown in FIGS. 1-3, transmitted key code 38 is preferably selected by user via, for exemplary purposes only and not meant to be limiting, multiple buttons (not shown), a display and menu structure (not shown), or other mechanisms known in the art. Activation signal 11, 41 comprises at least one transmitted key code 38 or a derivative thereof, and is transmitted via transmitting mechanism 40, where activation signal 11, 41 is received by receiving mechanism 10, as shown in FIG. 1.

In an alternate embodiment, locator 31 preferably comprises multiple activation buttons 43, wherein each activation button 43 transmits a separate transmitted key code 38 contained within key code database 37. Thus multiple keys 1 are preferably locatable via a single locator 31. In a preferred embodiment, locator 31 may also notify user which activation button 43 is sending activation signal 11, 41 through transmitter 40. Notification preferably ceases once activation signal 11, 41 is no longer transmitted through transmitter 40.

Referring now to FIGS. 1-3, in another preferred embodiment in which one locator 31 is used with multiple keys 1, each alarm 13 in each key 1, may be programmed to respond with different audio or visual signals, preferably different ring tones. Further, alarm 13 should function at suitable levels so location of key 1 may be determined by user.

Referring to FIG. 1, FIG. 2C, and FIG. 3, in another preferred embodiment, locator 31 may also include analog to digital or digital to analog converters (not shown) in electrical communication with power source 34, database 37, and transmitting mechanism 40, as necessary to transmit activation signal 11, 41 or deactivation signal 12, 42 via transmitting mechanism 40 and to convert transmitted key code 38 within signal 11, 12, 40, 41 to a transmittable format which may be compared with key code 5 upon reception at receiving mechanism 10 of key 1. Further, key 1 may also include analog to digital or digital to analog converters (not shown) in electrical communication with power source 7, memory mechanism 4, alarm 13 and receiving mechanism 10, as necessary to compare transmitted key code 38 with stored key code 5 of key 1.

Still referring to FIG. 1, FIG. 2C, and FIG. 3, power source 7, 34 may be provided internally or externally and preferably comprises any means of receiving or storing power known, such as, for exemplary purposes only, and not meant to be limiting, power stored in capacitors or batteries, or received via an electromagnetic field (not shown), or any combination thereof as may be contemplated.

Referring now to FIGS. 2B-3, in an alternate embodiment, locator 31 preferably comprises power source 34, key code database 37, and transmitting mechanism 40 all in electrical communication with each other. Transmitting mechanism 40 could include any type of communicable transmitting mechanism known, such as, for exemplary purposes only, a radio transmitter, an infrared transmitter, or a speaker. Key code database 37 preferably comprises at least one transmitted key code 38 or derivative thereof. Upon pressing activation button 43, transmitting mechanism 40 within locator 31 preferably generates activation signal 41, which is to be received by receiving mechanism 60, of key fob 51. Upon receiving activation signal 41, key fob 51 preferably generates for exemplary purposes, electromagnetic field 66 providing inductive coupling between key 1 and key fob 51, thereby to power key 1. Those skilled in the art would realize other means of remote powering may be used and electromagnetic field 66 is for exemplary purposes only and not meant to be limiting. Key 1 preferably actively transmits key code 5 stored in memory mechanism 4, wherein key code 5 is preferably received by key fob receiver 60. Necessary logic gates, software, and/or circuitry, not shown, in key fob 51 compare received key code 5 to transmitted key code 38. If transmitted key code 38 matches or resembles in a way to confirm authenticity with key code 5 received by key fob 51 and stored in memory mechanism 54, then alarm 63 is activated. Upon pressing deactivation button 43, as shown in FIG. 2B, transmitting mechanism 40 preferably ceases transmitting activation signal 11, 41 or may affirmatively send deactivation signal 42, thus resulting in cessation of alarm 63 of key fob 51.

In use, a method of locating key 1 is provided preferably comprising activating locator 31, transmitting activation signal 11, 41, wherein activation signal comprises transmitted key code 38, receiving activation signal 11, 41 at receiver 10 of key 1 or at receiver 60 of key fob 51, comparing transmitted key code 38 to key code 5 stored in key memory 4 or key fob memory 54, and notifying user of location of key 1 or key fob 51 via alarm 13 or alarm 63.

In a further use, the method preferably further comprises deactivating alarm 13 or alarm 63 once deactivation signal 12, 42 is received at key receiver 10 or key fob receiver 60. In an alternate method alarm 13 or alarm 63 is deactivated once activation signal 11, 41 ceases.

The foregoing description and drawings comprise illustrative embodiments of the present invention. Having thus described exemplary embodiments of the present invention, it should be noted by those skilled in the art that the embodiments within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A key locating apparatus comprising:
at least one key, wherein said at least one key has at least one internal key code;
a locator, wherein said locator is programmed with at least one transmitted key code, and wherein upon activation said locator sends an activation signal to said at least one key, said activation signal coded to said at least one transmitted key code; and
an alarm within said at least one key, wherein said alarm is activated by said activation signal sent from said locator.

2. The apparatus of claim 1, wherein said key further comprises:
a memory mechanism, wherein said memory mechanism contains said at least one internal key code;
a receiving mechanism, wherein said receiving mechanism receives said activation signal containing said at least one transmitted key code;
a comparator, wherein said comparator compares said at least one internal key code to said at least one transmitted key code;
a power source, wherein said alarm is activated if said at least one transmitted key code is authorized in relation to said at least one key code by said comparator.

3. The apparatus of claim 1, wherein said key further comprises:
a memory mechanism having at least one transmitted key code, a transmitting mechanism adapted to transmit said at least one transmitted key code, and a receiving power source;
a key fob comprising a power source a receiving mechanism adapted to receive said activation signal containing said at least one transmitted key code from said locator, wherein said receiving mechanism receives said at least one internal key code from said key, a memory mechanism, wherein said memory mechanism stores said transmitted key code, and a comparator adapted to compare said at least one internal key code to said transmitted key code, a power field generated by said power source and received by said receiving power source thus powering said key, wherein said alarm is activated if said at least one transmitted key code is authorized by said comparator in relation to said at least one internal key code.

4. The apparatus of claim 1, wherein a specific transmitted key code may be selected by a user out of said at least one transmitted key code, and wherein said specific transmitted key code is specifically coded to one of said at least one key.

5. The apparatus of claim 1, wherein said at least one internal key code is based on a manufacturer code, wherein said manufacturer code is preprogrammed into said key.

6. The apparatus of claim 1, wherein said alarm is an audible signal.

7. The apparatus of claim 1, wherein said alarm is a visual signal.

8. The apparatus of claim 1, wherein said at least one key comprises a power source to power said alarm.

9. The apparatus of claim 6, wherein said power source is selected from a group consisting of a battery, a capacitor, an electromagnetic field, and combinations thereof.

10. The apparatus of claim 6, wherein said power source is rechargeable.

11. The apparatus of claim 1, wherein said activation signal may be ceased by a deactivation mechanism disposed on said locator.

12. The apparatus of claim 1, wherein said alarm may be deactivated by a deactivation signal from said locator.

13. The apparatus of claim 1, wherein said locator comprises an attachment clip.

14. The apparatus of claim 1, wherein said locator comprises a notification, wherein said notification alerts a user said locator is transmitting said activation signal.

15. The apparatus of claim 1, wherein said locator further comprises a database comprising said at least one internal key code.

16. A method of locating a key, said method comprising the steps of:
activating a locator, wherein said activating step transmits a signal containing at least one transmitted key code from said locator;
receiving said signal at a key system, wherein said transmitted key code within said signal is specifically coded for said key system; and
notifying a user of the location of said key system via an alarm.

17. The method of claim 17 further comprising the step of:
deactivating said alarm via a deactivation signal sent from said locator.

18. The method of claim 17 wherein said signal is derived from a manufacturer code, and wherein said manufacturer code is preprogrammed into said key system.

19. The method of claim 17 further comprising the step of:
comparing said transmitted key code within said signal to a key code within said key system, wherein said notifying step only occurs if said transmitted key code is authorized via said comparing step.

20. A method of locating a key, said method comprising the steps of:
obtaining a mechanism made by a manufacturer, said mechanism having a coded key, wherein said coded key comprises a manufacturer key code;
obtaining a transmitted key code from an originator, wherein said transmitted key code is selected to be authenticated by said manufacturer key code, and wherein said transmitted key code is provided through a secure method;
obtaining a programmable transmitting mechanism;
programming said transmitted key code into said programmable transmitting mechanism;
transmitting said transmitted key code via said programmable transmitting mechanism;
receiving said transmitted key code at said coded key;
comparing said transmitted key code with said manufacturer key code; and
activating an alarm when said transmitted key code resembles said manufacturer key code in a way to confirm authenticity.
